(19) United States
(12) Patent Application Publication
(10) Pub. No.: US 2026/0051065 A1
(43) Pub. Date: Feb. 19, 2026

(54) UNIFIED ARCHITECTURE FOR INTERACTIVE AND SALIENT SEGMENTATION OF OBJECTS IN VIDEOS AND IMAGES

(71) Applicant: Samsung Electronics Co., Ltd., Suwon-si (KR)

(72) Inventors: Santhosh Kumar Banadakoppa NARAYANASWAMY, Bengaluru (IN); Shouvik DAS, Bengaluru (IN); Biplap Ch DAS, Bengaluru (IN); Sai Shashank KALAKONDA, Bengaluru (IN); Yadav SNEHLATA, Bengaluru (IN); Roy SHARAD, Bengaluru (IN); Sri Charan BIRUDARAJU, Bengaluru (IN); Kiran Nanjunda IYER, Bengaluru (IN)

(21) Appl. No.: 19/369,893

(22) Filed: Oct. 27, 2025

Related U.S. Application Data
(63) Continuation of application No. PCT/IB2025/056978, filed on Jul. 10, 2025.

(30) Foreign Application Priority Data
Jul. 11, 2024 (IN) 202441052995
Apr. 14, 2025 (IN) 202441052995

(51) Int. Cl. G06T 7/12; G06T 5/50; G06V 10/25; G06V 10/46

(52) U.S. Cl. CPC G06T 7/12; G06T 5/50; G06V 10/25; G06V 10/462; G06T 2207/20132; G06T 2207/20221; G06V 2201/07

(57) ABSTRACT

A method and an electronic apparatus for performing unified segmentation of media content are provided. The method includes: determining a guidance map for an input frame based on a salient object from a past frame output mask and user-interacted objects in the media, operating in either salient mode or selective mode. The input frame of the media is cropped based on the guidance map and the salient ROIs of the salient object. A weighted grayscale image of the cropped frame is generated from the past frame output mask. A fused spatio-color mesh grid representation of the cropped frame in YUV format is determined. The cropped image frame, along with the weighted grayscale image and the fused spatio-color mesh grid representation, is input into a segmentation model. The segmentation model generates either a salient object segmentation or a user-interacted object segmentation for the media.

### CROSS-REFERENCE TO RELATED APPLICATIONS

This application is a continuation of International Application No. PCT/IB2025/056978 designating the United States, filed on Jul. 10, 2025, in the Korean Intellectual Property Receiving Office and claiming priority to Indian Provisional Patent Application No. 202441052995, filed on Jul. 11, 2024, and Indian Complete patent application No. 202441052995, filed on Apr. 14, 2025, in the Indian Patent Office, the disclosures of each of which are incorporated by reference herein in their entireties.

### BACKGROUND

### Field

The disclosure relates to image processing. For example, the disclosure relates to an unified architecture for interactive and salient segmentation of objects in videos and images.

### Description of Related Art

Segmentation is a core technology available on the modern smartphone camera pipeline for development of various solutions such as image enhancement, image editing, sticker generation, and more. Segmentation tasks can be broadly categorized into several types, including salient segmentation, interactive segmentation, and image or video segmentation. Each of these tasks addresses specific needs within the realm of digital imaging.

Salient object segmentation aims to detect all salient objects within an image and accurately segment their regions. Interactive segmentation focuses on segmenting a salient object within a user-selected region. The segmentation tasks for images and videos differ significantly; video segmentation networks incorporate temporal stability and object tracking to ensure consistent performance over time.

Traditional neural networks used in existing segmentation techniques often rely on computation-heavy architectures to produce high-quality segmentation masks. This high computational demand poses challenges for real-time applications on mobile devices, which are constrained by limited processing power and memory. The necessity to use separate segmentation models for images and videos, as well as for salient and interactive segmentation, exacerbates these issues by increasing memory and power consumption, making such approaches impractical for mobile devices.

Real-time on-device image and video segmentation, specifically for salient and interactive object segmentation, includes generating high-quality segmentation masks for salient or user-selected objects in real-time. These objects can vary widely in shape, type, and size, adding to the complexity of the segmentation process. The computational intensity of performing accurate segmentation in real-time further complicates its implementation on mobile devices.

Further, salient and interactive object segmentation in video is challenging due to the need for maintaining temporal stability and effectively tracking objects throughout the video sequence. Ensuring that the segmentation remains consistent and accurate across frames is essential for delivering a seamless user experience, yet it demands significant computational resources.

The current state of segmentation technology presents several challenges for real-time mobile applications, including high computational demands, memory and power consumption, and the complexity of maintaining multiple segmentation models.

Thus, it is desired to address the above-mentioned disadvantages, issues, or other shortcomings, or at least provide a useful alternative.

### SUMMARY

Embodiments of the disclosure provide a unified architecture for interactive and salient segmentation of the objects in the videos and images.

Embodiments of the disclosure provide a unified architecture to detect salient objects prior to the segmentation.

Embodiments of the disclosure provide a unified architecture to perform the salient and selective segmentation of the image or video using a single segmentation model.

Embodiments of the disclosure provide a unified architecture to propagate past frame information for guiding the segmentation model.

According to an example embodiment a method for unified segmentation of media by an electronic apparatus is provided. The method includes: determining, by the electronic apparatus, a guidance map for an input frame based on at least one salient object, a past frame output mask, and a user-interacted object in the media in one of a salient mode and a selective mode; cropping, by the electronic apparatus, the input frame of an input media based on the guidance map and salient Region of Interests (ROIs) of the at least one salient object; determining, by the electronic apparatus, a past frame output mask weighted grayscale image of a cropped image frame; determining, by the electronic apparatus, a fused spatio-color mesh grid representation for the cropped image frame in a YUV format; inputting, by the electronic apparatus, the cropped image frame along with the past frame output mask weighted grayscale image and the fused spatio-color mesh grid representation to a segmentation model; and generating, by the electronic apparatus, one of a salient object segmentation and a user-interacted object segmentation for the media using the segmentation model in the electronic apparatus.

According to an example embodiment an electronic apparatus for performing a unified segmentation of the media is provided. The electronic apparatus includes: at least one processor, comprising processing circuitry, and a unified segmentation controller coupled with the processor, wherein the unified segmentation controller is configured to: determine a guidance map for an input frame based on a salient object, a past frame output mask, and a user-interacted object in the media in one of a salient mode and a selective mode; crop the input frame of an input media based on the guidance map and salient Region of Interests (ROIs) of the salient object; determine a past frame output mask weighted grayscale image of a cropped image frame; determine the fused spatio-color mesh grid representation for the cropped image frame in a YUV format; input the cropped image frame along with the past frame output mask weighted grayscale image and the fused spatio-color mesh grid representation to a segmentation model; and generate one of a salient object segmentation and a user-interacted object segmentation for the media using the segmentation model in the electronic apparatus.

These and other aspects of the disclosure will be better understood with the following description and accompanying drawings. The descriptions, indicating various example embodiments and specific details, are for illustration only and not for limitation. Many changes and modifications can be made within the scope of the disclosure.

### BRIEF DESCRIPTION OF THE DRAWINGS

The features, aspects, and advantages of certain embodiments of the present disclosure will be more apparent from the following detailed description, taken in conjunction with the accompanying drawings, where like reference letters indicate corresponding parts, and in which:

FIG. 1A is a diagram illustrating a salient video segmentation on video input according to prior art;

FIG. 1B is a diagram illustrating a salient video segmentation on video input according to prior art;

FIG. 1C is a diagram illustrating a salient image segmentation on image input according to prior art;

FIG. 1D is a diagram illustrating a salient image segmentation on image input according to prior art;

FIG. 1E is a diagram illustrating a salient image segmentation on video input according to prior art;

FIG. 1F is a diagram illustrating a salient video segmentation on video input in interactive segmentation scenario according to prior art;

FIG. 1G is a diagram illustrating a salient video segmentation on video input in interactive segmentation scenario according to prior art;

FIG. 2 is a flowchart illustrating an example method for unified segmentation of media by an electronic apparatus according to various embodiments;

FIG. 3A is a block diagram illustrating an example configuration of an electronic apparatus for performing unified segmentation of media according to various embodiments;

FIG. 3B is a block diagram illustrating an example configuration of a unified segmentation controller configured to perform unified segmentation of media according to various embodiments;

FIG. 3C is a block diagram illustrating an example configuration of a salient object detection unit configured to detect salient objects in an input frame according to various embodiments;

FIG. 4 is a diagram illustrating example adaptation of guidance map for the input frame according to various embodiments;

FIG. 5 is a diagram illustrating a comparison of an output frame obtained with guidance map and without guidance map according to various embodiments;

FIG. 6 is a diagram illustrating example cropping of the input frame in salient mode using guidance map according to various embodiments;

FIG. 7 is a diagram illustrating example cropping of the input frame in selective mode using guidance map according to various embodiments;

FIG. 8 is a diagram illustrating example determination of the weighted grayscale representation of the input frame according to various embodiments;

FIG. 9 is a diagram illustrating example spatio-color mesh grid representation of the input frame according to various embodiments;

FIG. 10A is a diagram illustrating example salient segmentation of the input frame and selective segmentation of the input frame according to various embodiments;

FIG. 10B is a diagram illustrating example salient segmentation of the input frame and selective segmentation of the input frame according to various embodiments;

FIG. 11A is a diagram illustrating example salient segmentation and a selective segmentation of the input frame according to various embodiments;

FIG. 11B is a diagram illustrating example salient segmentation and a selective segmentation of the input frame according to various embodiments;

FIG. 11C is a diagram illustrating example salient segmentation and a selective segmentation of the input frame according to various embodiments;

FIG. 12A is a diagram illustrating example segmentation of the image in motion clipper or motion clipper according to various embodiments; and

FIG. 12B is a diagram illustrating example segmentation of the image in motion clipper or motion clipper according to various embodiments.

### DETAILED DESCRIPTION

Like reference numerals represent like elements in the drawings. Elements are illustrated for simplicity and may not be to scale; some dimensions may be exaggerated for clarity. Existing symbols may be used, and pertinent details are shown to avoid obscuring the drawing with readily apparent information to those skilled in the art.

Various embodiments are described and illustrated in terms of blocks that carry out a described function or functions. These blocks, which are referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. The circuits, for example, may be embodied in one or more semiconductor chips or on substrate supports such as printed circuit boards and the like. The circuits of a block may be implemented by dedicated hardware or by a processor (e.g., one or more programmed microprocessors and associated circuitry) or by a combination of dedicated hardware to perform some functions of the block and a processor to perform other functions of the block. Each block of the example embodiments may be physically separated into two or more interacting and discrete blocks without departing from the scope of the disclosure. Likewise, the blocks of the example embodiments may be physically combined into more complex blocks without departing from the scope of the disclosure.

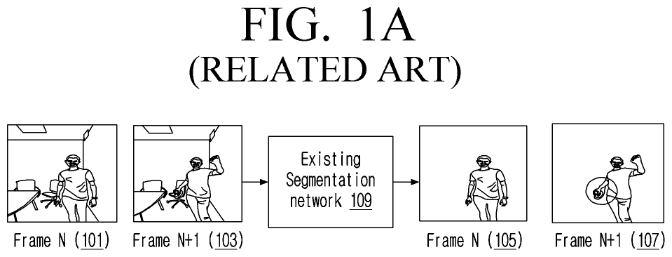

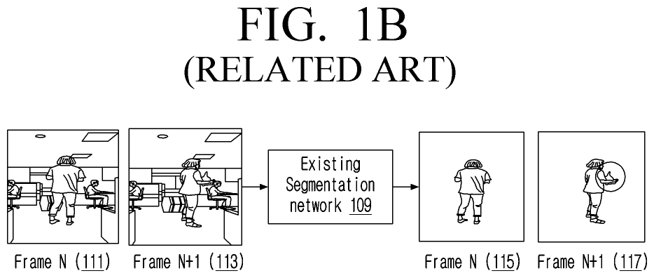

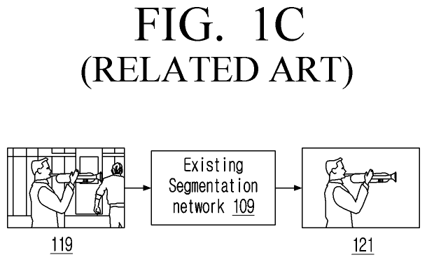

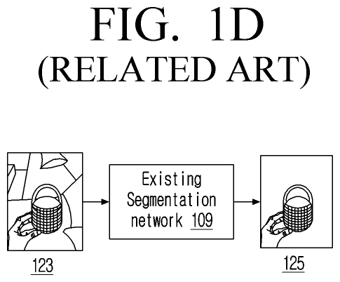

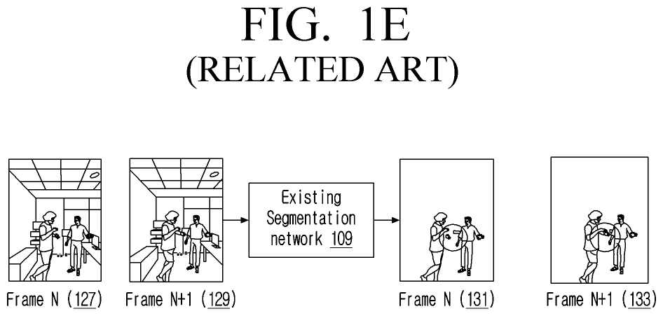

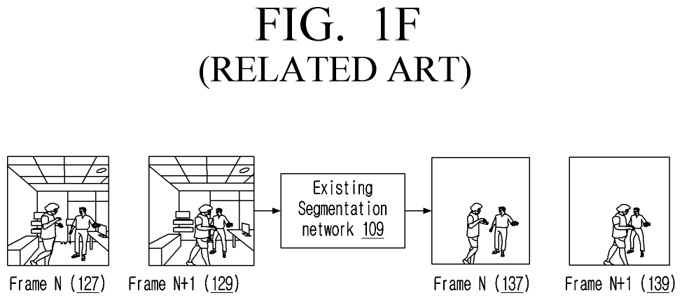

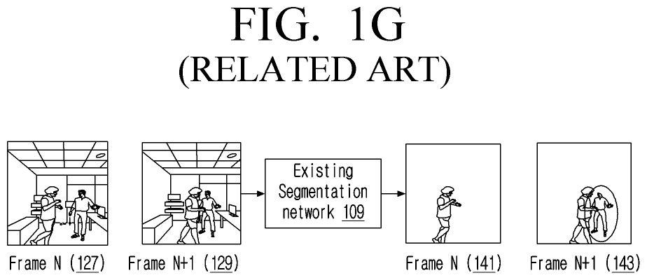

Referring now to the drawings, and more particularly to FIG. 1 through FIG. 12 where similar reference characters denote corresponding features consistently throughout the drawings, there are shown various example embodiments.

As shown in FIG. 1A, consider a frame N (101) of a video where a person is standing near a chair and a frame N+1 (103) of the video in which the person is moving the hand up while standing near the chair. Further, the frame N (101) and the frame N+1 (103) is provided as an input to an existing salient video segmentation network (109). The existing salient video segmentation network (109) performs the segmentation of salient objects in the frame N (101) and frame N+1 (103). Upon segmentation, the existing salient video segmentation network (109) generates an outframe N (105) for the input frame N and an output frame N+1 (107) of the input frame N+1 (103). The existing salient video segmentation network (109) has falsely predicted a portion of the chair as the object as indicated in the outframe N+1 (107), thus decreasing temporal stability and affecting the user experience.

Similarly, in FIG. 1B, consider a frame N (111) of a video where a person is standing and a frame N+1 (113) of the video in which the person is holding an object in the hand. Further, the frame N (111) and the frame N+1 (113) is provided as an input to an existing salient video segmentation network (109). The existing salient video segmentation network (109) performs the segmentation of salient objects in the frame N (111) and frame N+1 (113). Upon segmentation, the existing salient video segmentation network (109) generates an outframe N (115) for the input frame N (111) and an output frame N+1 (117) of the input frame N+1 (113). The existing salient video segmentation network (109) has partially segmented the object held by the person as indicated in the outframe N+1 (117), thus affecting the user experience.

As shown in FIG. 1C, an input frame (119) being an image is input to the existing salient image segmentation network (109). Further, the existing salient image segmentation network (109) performs the segmentation of the image and generates an output frame (121). Similarly, in FIG. 1D, an input frame (123) being an image is input to the existing salient image segmentation network (109). Further, the existing salient image segmentation network (109) performs the segmentation of the image and generates an output frame (125). As shown in FIG. 1E, consider an input frame N (127) and a frame N+1 (129) of a video in which there are two people interacting with each other and is provided as an input to the existing segmentation network (109). For example, the existing salient image segmentation network (109) can include but is not limited to an InSPyReNet. Further, the existing salient image segmentation network (109) performs the segmentation of the input frame N (127) and the input frame N+1 (129) and generates an output frame N (131) and the frame N+1 (133). The output frame N (131) and the output frame N+1 (133) are generated with noisy segmentation as indicated. Similarly, as shown in FIG. 1F, the salient segmentation of the input frame N (127) and a frame N+1 (129) generates the output of frame N (137) and output of frame N+1 (139) where the segmented objects in the frame are noisy. Further, FIG. 1G illustrates the selective segmentation of the input frame N (127) and a frame N+1 (129) generates the output of frame N (141) and output of frame N+1 (143) where the segmented objects in the frame are noisy. Thus, the salient video segmentation network segments all the salient objects in the input frame. Also, in the interactive segmentation in frame N (127) when both persons are separate, the segmentation output obtained is correct. When both the persons in the frame (N+1) are overlapping, due to the network's tendency to segment all the valid salient objects in the output frame N+1 (141), part of the other person is also segmented, leading to a poor experience.

The existing segmentation networks on images and videos are different as the video segmentation networks need to incorporate temporal stability and object tracking. Traditional neural networks in the prior art use computation-heavy neural networks to produce high-quality segmentation masks, which makes it difficult to use them for real-time mobile device applications. The usage of separate segmentation models for images and videos and for salient and interactive segmentation leads to a large requirement of memory and power consumption, which is not feasible on mobile devices.

The disclosure provides a method for unified segmentation of the media by the electronic apparatus. The method includes determining a guidance map for an input frame based on at least one salient object, a past frame output mask, and a user-interacted object in the media in one of a salient mode and a selective mode. Further, the method includes cropping the input frame of an input media based on the guidance map and salient Region of Interests (ROIs) of the at least one salient object. Further, the method includes determining a past frame output mask weighted grayscale image of a cropped image frame. Further, the method includes determining a fused spatio-color mesh grid representation for the cropped image frame in a YUV format. Further, the method includes inputting the cropped image frame along with the past frame output mask weighted grayscale image and the fused spatio-color mesh grid representation to a segmentation model. Further, the method includes generating one of a salient object segmentation and a user-interacted object segmentation for the media using the segmentation model in the electronic apparatus.

The disclosure intelligently segments both the image or video using the same segmentation engine in salient and interactive mode using a single forward pass. The disclosure provides an representation of past frame information while propagating it to the current frame that provides an accurate segmentation of the objects in the media. Using a single segmentation model for multiple segmentation tasks enhances memory management and reduces power consumption. This unified approach simplifies the overall architecture and ensures that the segmentation process is both time-efficient and resource-efficient, making it highly suitable for real-time applications on mobile devices. By addressing the limitations of existing segmentation networks, the disclosure significantly improves user experience by offering more accurate and stable segmentation results.

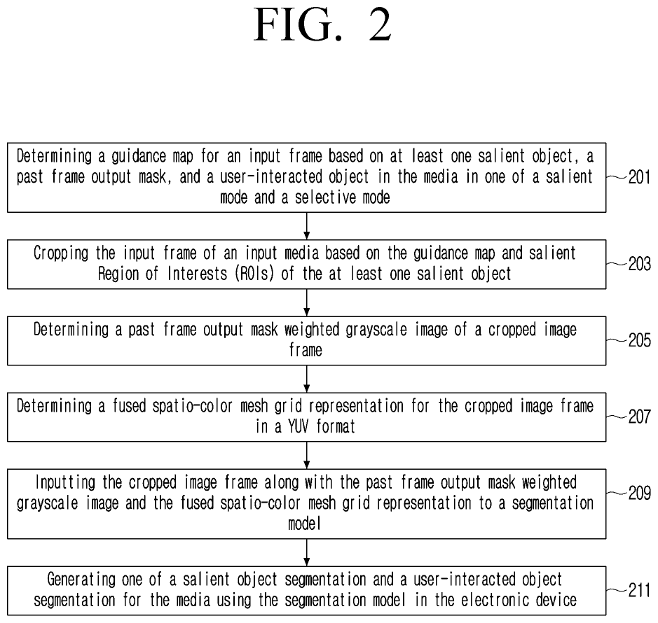

FIG. 2 is a flowchart illustrating an example method for unified segmentation of media by the electronic apparatus according to various embodiments. At block 201, the method includes determining a guidance map for an input frame based on at least one salient object, a past frame output mask, and a user-interacted object in the media in one of a salient mode and a selective mode. For example, the media can include, but is not limited to, an image or video. The guidance map is the salient ROIs of the input frame or the segmentation output of the past frame. At block 203, the method includes cropping the input frame of the input media based on the guidance map and salient Region of Interests (ROIs) of the at least one salient object. At block 205, the method includes determining a past frame output mask weighted grayscale image of a cropped image frame. At block 207, the method includes determining a fused spatio-color mesh grid representation for the cropped image frame in a YUV format. At block 209, the method includes inputting the cropped image frame along with the past frame output mask weighted grayscale image and the fused spatio-color mesh grid representation to a segmentation model. At block 211, the method includes generating one of a salient object segmentation and a user-interacted object segmentation for the media using the segmentation model in the electronic apparatus.

In an embodiment, to detect the at least one salient object in the input frame of the input media in the salient mode, the method may include generating the bounding box for the one or more objects present in the input frame. The method may include determining the at least one of a height and width of the bounding box, centerness of the bounding box, and the category of the objects in the bounding box. The method may include determining the combined score for all the bounding boxes based on the height and width of the bounding box, centerness of the bounding box, and the category of the objects in the bounding box. The method may include detecting the at least one salient object in the input frame of an input media based on the combined score of the bounding box. The input media is at least one of an image or video.

In an embodiment, to detect the at least one salient object in the current frame of the input media in the selective mode, the method may include displaying the plurality of salient objects in the input frame of the input media on a screen of the electronic apparatus. The method may include receiving an input (e.g., a user input) to select of at least one salient object from the plurality of salient objects. The method may include detecting the at least one salient object in the input frame of the input media in the selective mode based on the user input.

In an embodiment, the guidance map may include the at least one salient Region of Interest (ROIs) of the input frame when the input frame is the image or when the input frame is a first frame of the video. In an embodiment, the guidance map may be a segmentation output of the past frame when the input frame is not the image or when the input frame is not a first frame of the video. In an embodiment, to crop the input frame in the salient mode, the method may include determining at least one salient ROIs having intersection in the input frame among the at least one salient object. The method may include generating the cropped image frame of the input frame by combining the at least one salient ROIs and the guidance map of the input frame when the input media is the image and when the input frame is the first frame of the video. The method may include generating the cropped image of the input frame by combining the at least one salient ROIs and the guidance map of the past frame when the input media is the video and the input frame is not the first frame.

In an embodiment, to crop the input frame in the selective mode, the method may include determining at least one salient ROIs having intersection in the input frame among the at least one salient object. The method may include receiving the user input select of at least one selected coordinates from the plurality of salient objects. The method may include generating the cropped image of the input frame by combining the at least one salient ROIs, a guidance map with selected coordinates of the input frame when the input media is the image and when the input frame is the first frame of the video. The method may include generating the cropped image of the input frame by combining the at least one salient ROIs and the guidance map of the past frame when the input media is the video and the input frame is not the first frame.

In an embodiment, to determine the past frame output mask weighted grayscale image of a cropped image frame, the method may include overlaying the past frame segmentation output on a past frame grayscale representation with a proportion. The method may include determining the past frame output mask weighted grayscale image of a cropped image based on the overlaying. In an embodiment, the fused spatio-color mesh grid comprises a U-channel, a V-channel, and an X-Y component fused together.

The unified segmentation solution described herein provides a robust and efficient approach to media processing, accommodating both salient and selective modes for object detection and segmentation. This dual-mode capability enables the method to adapt to various user requirements and media types, enhancing its applicability in diverse scenarios. For instance, in automated video editing, the salient mode can quickly identify and segment key objects without user intervention, streamlining the editing process. The selective mode empowers users to manually select specific objects for segmentation, offering greater control and precision in tasks such as interactive media annotation or custom content creation.

The integration of past frame output masks and fused spatio-color mesh grids into the segmentation model significantly improves the accuracy and consistency of the segmentation results. By leveraging historical data and spatial-color information, the method can maintain continuity and coherence across frames. This approach minimizes/reduces segmentation errors and reduces the computational load by focusing on the relevant regions of interest, thereby optimizing the overall performance of the electronic apparatus.

The ability of the method to generate and utilize guidance maps based on various criteria (e.g., salient ROIs, user interactions, past frame outputs) highlights its versatility and adaptability. This feature allows the method to cater to different media types and user preferences. Whether used in professional video production, real-time object tracking, or interactive media experiences, the unified segmentation method offers a comprehensive solution.

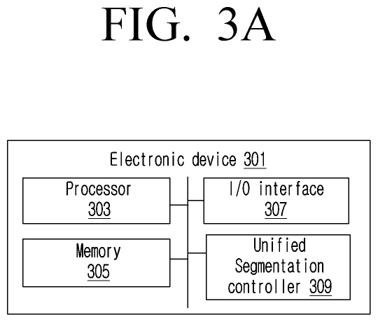

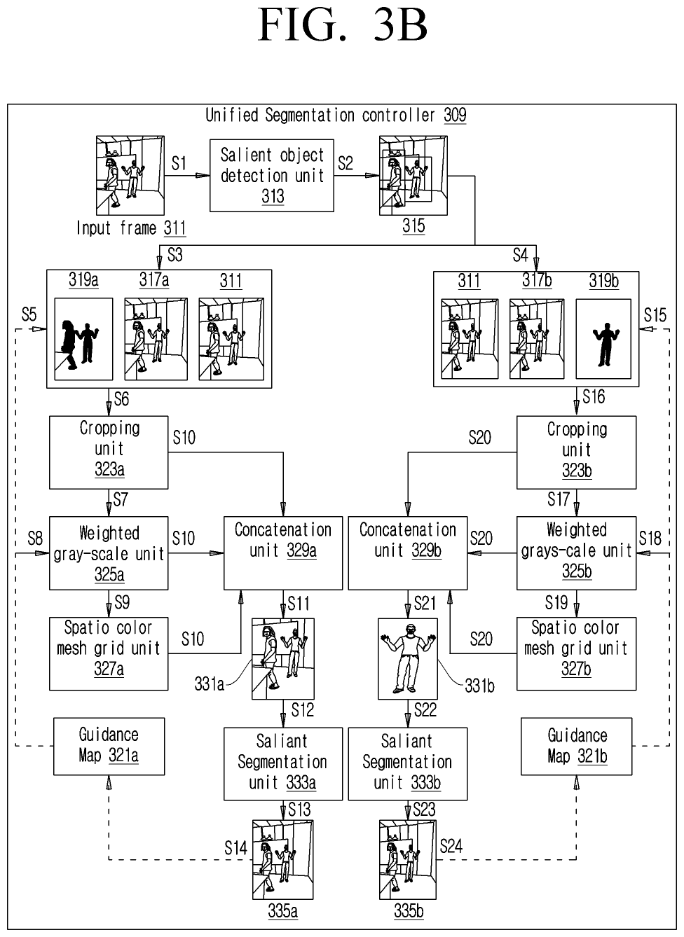

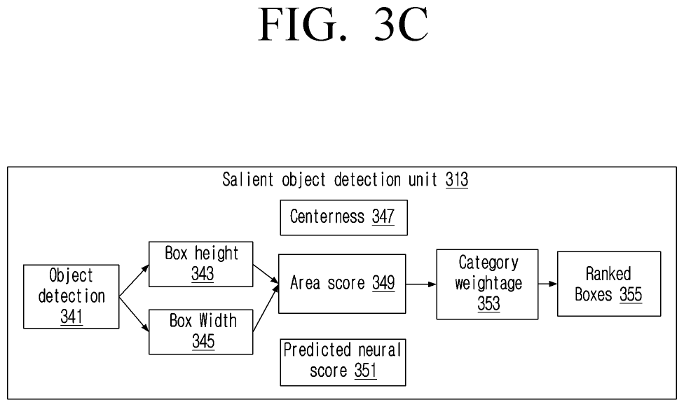

FIG. 3A is a block diagram illustrating an example configuration of the electronic apparatus for performing unified segmentation of media, according to various embodiments. The electronic apparatus (301) includes a processor (e.g., including processing circuitry) (303), a memory (305), an I/O interface (e.g., including I/O circuitry) (307), and a unified segmentation controller (e.g., including various circuitry) (309). The processor (303) of the electronic apparatus (301) communicates with the memory (305), the I/O interface (307), and the unified segmentation controller (309). The processor (303) executes instructions stored in the memory (305) and to perform various processes. The processor (303) can include one or a plurality of processors, can be a general-purpose processor such as a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU). Each “processor” or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

The memory (305) of the electronic apparatus (301) includes storage locations that can be addressed through the processor (303). The memory (305) is not limited to volatile or non-volatile memory and can include one or more computer-readable storage media. Non-volatile storage elements such as magnetic hard disks, optical discs, floppy discs, flash memories, EPROM, or EEPROM memories can also be included in the memory (305). Further, the memory (305) of the electronic apparatus (301) can store various information such as the guidance map, cropped image of the input frame, weighted grayscale image of the cropped image, fused spatio-color mesh grid representation of the cropped image and the like.

The I/O interface (307) may include various circuitry and transmits information between the memory (305) and external peripheral devices, which are input-output devices associated with the electronic apparatus (301). This interface is used to maintain seamless communication between the electronic apparatus (301) and external apparatus/apparatuses, ensuring that data is transmitted and received.

The unified segmentation controller (309) may include various circuitry and is coupled to the I/O interface (307) and the memory (305) for unified segmentation of media by an electronic apparatus. This coupling allows for data transfer and communication between the components, ensuring that the unified segmentation controller (309) performs the unified segmentation of the media. The unified segmentation controller (309) may include an innovative integrated circuit implemented in the electronic apparatus (301). In an embodiment, the structure of such an innovative integrated circuit includes a multi-core architecture that ensures the generation of segmentation masks for all of the salient objects or selected objects in both the images and the video. Each core is optimized for specific tasks such as determination of the guidance map, cropping of the input frame based on the guidance map, generating past frame output mask weighted grayscale image, and the fused spatio-color mesh grid representation of the cropped image. The innovative integrated circuit for unified segmentation of the media is made of a combination of analog and digital components designed to perform the unified segmentation. The analog components include a low-noise amplifier and a high-precision analog-to-digital converter to ensure accurate signal processing. The digital components include a microcontroller unit (MCU) and a digital signal processor (DSP) that work in tandem to handle the temporary capability restriction during MUSIM operations in the communication network system. Further, the multi-core architecture allows for parallel processing, which significantly reduces the latency and enhances the real-time performance of the segmentation tasks. Thus, the unified segmentation controller (309) may include various processing circuitry and the description of the processor 303 above applied equally thereto.

The unified segmentation controller (309) determines the guidance map for the input frame based on the at least one salient object, the past frame output mask, and the user-interacted object in the media in one of the salient mode and the selective mode. The unified segmentation controller (309) crops the input frame of the input media based on the guidance map and salient ROIs of the salient object. Further, the unified segmentation controller (309) determines the past frame output mask weighted grayscale image of the cropped image frame. Further, the unified segmentation controller (309) determines the fused spatio-color mesh grid representation for the cropped image frame in a YUV format. The unified segmentation controller (309) inputs the cropped image frame along with the past frame output mask weighted grayscale image and the fused spatio-color mesh grid representation to a segmentation model. The unified segmentation controller (309) generates one of the salient object segmentation and the user-interacted object segmentation for the media using the segmentation model in the electronic apparatus (301). The segmentation model may include a deep learning-based neural network that has been trained on a large dataset of annotated images and videos to accurately segment objects. The model utilizes convolutional layers to extract features and fully connected layers to classify and segment the objects. The segmentation results are then refined using post-processing techniques such as conditional random fields (CRFs) to ensure smooth and accurate boundaries.

In an embodiment, to detect the salient object in the input frame, the unified segmentation controller (309) generates the bounding box for one or more objects present in the input frame. The unified segmentation controller (309) determines the at least one of the height and the width of the bounding box, centerness of the bounding box, and the category of the objects in the bounding box. For example, the category of the objects can include, but not limited to, humans, cats and dogs, vehicles, and animals, electronic and home appliances, plants, and food. Also, based on the categories, the weight assigned for the objects detected in the input frame. Further, the unified segmentation controller (309) determines the combined score for all the bounding boxes based on the height and width of the bounding box, centerness of the bounding box, and the category of the objects in the bounding box. Further, the unified segmentation controller (309) detects the at least one salient object in the input frame based on the determined combined score of the bounding box. The bounding box generation is performed using a region proposal network (RPN) that scans the input frame and proposes potential object regions. The centerness score is calculated to prioritize objects that are centrally located within the bounding box, enhancing the accuracy of the salient object detection.

In an embodiment, to detect the salient object in the input frame of the input media in the selective mode, the unified segmentation controller (309) displays the plurality of the salient objects in the input frame of the input media on the screen of the electronic apparatus (301 The unified segmentation controller (309) receives the user input select of the at least one salient object from the plurality of salient objects. For example, the user of the electronic apparatus (301) can select a particular object in the input frame that needs to be segmented. Further, the unified segmentation controller (309) detects the at least one salient object in the input frame of the input media in the selective mode based on the user input. The user input can be received through various input methods such as touch, stylus, or voice commands, providing flexibility in user interaction. The selected object is then highlighted and tracked across subsequent frames to maintain consistent segmentation throughout the media.

In an embodiment, the input media can be the image or the video. The unified segmentation controller (309) is designed to handle both static images and dynamic video frames, ensuring versatility in its application. The controller can process high-resolution images and videos, supporting various formats such as JPEG, PNG, MP4, and AVI. The segmentation results can be output in different formats, including binary masks, colored overlays, and vector representations, depending on the requirements of the application.

In an embodiment, the guidance map may include at least one salient ROIs of the input frame when the input frame is the image or when the input frame is a first frame of the video. The guidance map serves as a reference for the segmentation model, highlighting the regions of interest that need to be segmented. The map may be generated using a combination of edge detection, saliency detection, and object recognition techniques to ensure accurate identification of the salient regions. The guidance map may be updated dynamically as new frames are processed, ensuring that the segmentation remains consistent and accurate throughout the media.

In an embodiment, the guidance map may be the segmentation output of the past frame of the input frame when the input frame is not the image or when the input frame is not a first frame of the video. This approach leverages temporal consistency in video frames to improve segmentation accuracy. The past frame segmentation output may be used as a reference to guide the segmentation of the current frame, reducing the computational load and enhancing the segmentation process. The guidance map may be refined using motion estimation and optical flow techniques to account for changes in object position and appearance between frames.

In an embodiment, to crop the input frame, the unified segmentation controller (309) may determine the at least one salient ROIs having intersection in the input frame among the at least one salient object. The unified segmentation controller (309) may generate the cropped image frame of the input frame by combining the at least one salient ROIs and the guidance map of the input frame when the input media is the image and when the input frame is the first frame of the video. The unified segmentation controller (309) may generate the cropped image of the input frame by combining the at least one salient ROIs and the guidance map of the past frame when the input media is the video and the input frame is not the first frame. The cropping process includes calculating the bounding box coordinates for the salient ROIs and extracting the corresponding pixel values from the input frame. The cropped image may then be resized and normalized to match the input requirements of the segmentation model, ensuring consistent and accurate segmentation results.

In an embodiment, to crop the input frame, the unified segmentation controller (309) may determine the at least one salient ROIs having an intersection in the input frame among the at least one salient object. The unified segmentation controller (309) receives the user input select of at least one selected coordinates from the plurality of salient objects. Further, the unified segmentation controller (309) generates the cropped image of the input frame by combining the at least one salient ROIs, the guidance map with selected coordinates of the input frame when the input media is the image and when the input frame is the first frame of the video. The unified segmentation controller (309) generates the cropped image of the input frame by combining the at least one salient ROIs and the guidance map of the past frame when the input media is the video and the input frame is not the first frame. The user-selected coordinates are used to refine the cropping process, ensuring that the object is accurately segmented. The coordinates are mapped to the input frame, and the corresponding region is extracted and processed for segmentation.

In an embodiment, to determine the past frame output mask weighted grayscale image of the cropped image, the unified segmentation controller (309) overlays the past frame segmentation output on the past frame grayscale representation with a proportion. Further, the unified segmentation controller (309) determines the past frame output mask weighted grayscale image of a cropped image based on the overlaying. The overlay process includes blending the past frame segmentation mask with the grayscale representation using a weighted sum, where the weights are determined based on the confidence scores of the segmentation model. This approach ensures that the past frame output mask accurately represents the salient regions while preserving the grayscale information of the image.

In an embodiment, the fused spatio-color mesh grid includes the U-channel, the V-channel, and the X-Y component fused together. The U-channel and V-channel represent the chrominance information, while the X-Y component represents the spatial coordinates of the pixels. The fusion process includes combining these channels into a single representation that captures both the color and spatial information of the cropped image. This fused representation is then used as input to the segmentation model, enhancing its ability to accurately segment objects based on both color and spatial features. The fusion process is performed using a combination of linear and non-linear transformations to ensure that the resulting representation is robust and discriminative.

FIG. 3B is a block diagram illustrates an example configuration of the unified segmentation controller configured to perform unified segmentation of the media, according to various embodiments.

At step S1, consider an input frame (311) is provided as an input to a salient object detection unit (313) of the unified segmentation controller (309). The salient object detection unit (313) detects the ROIs for the salient objects in the input frame (311) and assigns a rank to the ROIs based on a ROI height, width, centerness and category of the salient objects. Further, the salient object detection unit (313) provides an output of sorted ROIs based on the ranks (hereinafter rank is interchangeably used as saliency score). As shown in FIG. 3C for detecting ROIs for the salient objects in the input frame (311) at block 341, the salient object detection unit (313) generates the bounding boxes for the objects present in the input frame (311). The bounding box is a regular of square-shaped box used to define a position and spatial extent of the object within the input frame (311). The input frame (311) can be an image or the video frame. Upon generating the bound box, at block 343, the salient object detection unit (313) determines the height of the bounding box and at block 345, the salient object detection unit (313) determines the width of the bounding box. Further at block 347, the salient object detection unit (313) determines the centerness of the bounding box, where the centerness indicates how a close the bounding box is to the center of the object. The centerness is determined using the below equation 1, where Cx=0.5

$$* ( x 1 + x 2 ) / W , Cy = 0.5 * ( y 1 + y 2 ) / H , \qquad 1$$

$$Centerness = = 1. - √ ( Cx - 0.5 ) 2 + ( Cy - 0.5 ) 2$$

At block 349, the salient object detection unit (313) determines the area score and at block 351, the salient object detection unit (313) determines a predicted neural score. The area score refers to the percentage of the bounding box area relative to the total image area. The area score is determined using the below equation 2:

$$Area Score := ( ( y 2 - y 1 ) / H ) * ( ( x 2 - x 1 ) / W ) - 2 \qquad 2$$

The predicted neural score is a confidence score that represents the model's certainty about the detected object's presence and class, calculated using the combination of objectness probability and IoU. Further at block 353, the salient object detection unit (313) determines a weight for the objects based on the category of the object. For example, the category is allocated with a predefined (e.g., specified) weight such as shown in below table 1:

TABLE 1

| Category | Category Weight |
|---|---|
| Human | 1.0 |
| Cats & Dogs | 0.95 |
| Vehicles and Animals | 0.8 |
| Electronics and Home Appliances | 0.7 |
| Plants and Food | 0.6 |

At block 355, the salient object detection unit (313) determines a combined score for the bounding box based on the category weight, centerness, the area sore and the neural score. The combined score is determined using the below equation 3:

$$Combined Score = * Category Weight [ Id ] * ( 0.6 * Centerness + 0.1 * AreaScore + 0.3 * NeuralScore ) \qquad 3$$

Based on the combined score the ranks are assigned to the bounding box. Furthermore, the bounding box with highest ranks are selected for further segmentation.

At step S2, the salient object detection unit (313) provides an output of the input frame that includes the bounding boxes that are highest ranked and which are further processed for segmentation. The block 315 indicates the bounding boxes which are highest ranked and are selected for the segmentation. The objects in the selected bounding boxes are referred to as the salient objects of the input frame.

Upon the salient object detection unit (313), the unified segmentation controller (309) determines whether a user input has been received on the input frame. The user input (user input is interchangeably used as the user interacted object) can include an object being selected in the input frame (311).

At step S3, the unified segmentation controller (309) performs the segmentation in a salient mode when there is no user input received. During the salient mode segmentation, all the detected salient objects in the input frame (311) are considered for the segmentation. Further, the steps S6-S14 indicate the segmentation in the salient mode.

At step S4, the unified segmentation controller (309) performs the segmentation in the selective mode. During the selective mode segmentation, the objects that are selected by the users are considered for the segmentation. Also, the steps S15-S24 indicate the segmentation in selective mode.

In an embodiment, the salient object detection unit (313) performs the step S3 and step S4 parallelly when the user input is received where the user has selected a particular object in the input frame (311) for the segmentation.

At step S5, the guidance map unit (321a) constructs the guidance map. The guidance map is constructed to propagate past frame information based on the input frame. In the disclosure, the guidance map is adapted based on the input stream or input media. For example, when the input media is the image, then the guidance map is constructed based on the detected salient objects.

The detected bounding boxes are used as the guidance map. In an embodiment, when the input media is the video, then the guidance map is constructed based on the segmentation output of the previous frame. However, when the input frame (311) is the first frame of the video, then the guidance map is constructed based on the detected salient objects. The guidance map enables the information transfer in past and present frames, leading to improved temporal stability. The block 319a is the guidance map for input frame 311. The salient objects detected in the input frame (311) are used as the guidance map.

Upon determining the guidance map, further at step S6, the guidance map is provided as the input to a cropping unit (323a) of the unified segmentation controller (309). The cropping unit (323a) performs the cropping of the input frame (311) based on the guidance map (319a) and salient ROIs in the salient objects. The cropping unit (323a) determines a intersection between the bounding boxes of the detected salient objects. Further, the cropping unit (323a) performs a union of the intersecting ROIs of the bounding boxes and the guidance map (319a) that results in the cropped image.

At step S7, the cropped unit (323a) provides the cropped image as the input to the weighted grayscale unit (325a). At step S8, the guidance map unit (321a) inputs the guidance map to the weighted grayscale unit (325a). The weighted grayscale unit (325a) overlays the guidance map with a past frame grayscale representation to generate the past frame output mask weighted grayscale image. The overlaying outputs the past frame output mask weighted grayscale image of the cropped image. The weighted grayscale unit (325a) constructs a 4th channel which propagates the context information of the past frame to maintain temporal stability where the weighted grayscale unit (325a) performs the below steps:

For each pixel (i, j) in (H,W)

$$If segmentation\_output ( i , j ) = 0 ,$$

$$result = 0.2 * grayscale\_image ( i , j ) + 0.8 * 20$$

$$If segmentation\_output ( i , j ) = 255 ,$$

$$result = 0.2 * grayscale\_image ( i , j ) + 0.8 * 240$$

Further at step S9, the weighted gray-scale unit (325a) inputs the past frame output mask weighted grayscale image to a spatio-color mesh grid unit (327a). The spatio-color mesh grid unit (327a) constructs a 5th channel which propagates the color and positional information of the past frame to maintain temporal stability. This 5th channel ensures that the color consistency and spatial coherence are preserved across frames. The spatio-color mesh grid unit (327a) constructs a fused spatio-color mesh grid using color channels (UV) of the past frame and X Y gradient. The X Y gradient helps in capturing the spatial variations, while the UV channels retain the chromatic information. The channels of the past frame are obtained using YUV encoding of the past frame, which separates the luminance and chrominance components, facilitating processing and storage.

At step S10, the cropped image, the past frame output mask weighted grayscale image, and the fused spatio-color mesh grid are input to a concatenation unit (329a). The concatenation unit (329a) concatenates the cropped image, the past frame output mask weighted grayscale image, and the fused spatio-color mesh grid to generate a pre-processed image (331a) of the input frame (311). The pre-processed image (331a) are the cropped versions of shaded background. This concatenation ensures that all relevant information from the past and current frames is combined into a single representation. Further at step S12, the pre-processed image (331a) is input to a salient segmentation unit (333a). The salient segmentation unit (333a) performs the segmentation and generates the segmentation output (335a). The segmentation unit uses advanced algorithms to accurately delineate the boundaries of salient objects. Further at step S14, the segmentation output (335a) can be used as the input for the segmentation of the next frame in the video, ensuring continuity and consistency in the segmentation process.

During the selective mode segmentation, the segmentation is performed for the selected object provided by the user as the input. This mode allows for focused processing, reducing computational load and improving efficiency. The user can specify the object of interest, and the system will track and segment only that object across frames.

At step S15, the guidance map is generated by a guidance map unit (321b). The guidance map is constructed to propagate past frame information based on the input frame. In the disclosure, the guidance map is adapted based on the input stream or input media. For example, when the input media is an image, the guidance map is constructed based on the selected salient objects. The guidance map ensures that the segmentation process is informed by the context of previous frames, enhancing accuracy. The detected bounding boxes are used as the guidance map. In an embodiment, when the input media is a video, the guidance map is constructed based on the segmentation output of the previous frame. However, when the input frame (311) is the first frame of the video, the guidance map is constructed based on the selected object. The guidance map enables the information transfer in past and present frames, leading to improved temporal stability. The block 319b is the guidance map for the selected object of the input frame 311. The selected object in the input frame (311) is used as the guidance map.

Upon determining the guidance map, further at step S16, the guidance map is provided as the input to a cropping unit (323b) of the unified segmentation controller (309). The cropping unit (323b) performs the cropping of the input frame (311) based on the guidance map (319b) and salient ROIs of the selected objects. The cropping unit (323b) determines the intersection between the bounding boxes of the salient objects. This ensures that the cropped region accurately encompasses the area of interest. Further, the cropping unit (323a) performs a union of the intersecting ROIs of the bounding boxes and the guidance map (319b) that results in the cropped image. This union operation ensures that all relevant regions are included in the cropped image, providing a comprehensive input for subsequent processing.

At step S17, the cropped unit (323b) provides the cropped image as the input to the weighted grayscale unit (325b). At step S18, the guidance map unit (321b) inputs the guidance map to the weighted gray-scale unit (325b). The weighted grayscale unit (325a) overlays the guidance map with a past frame grayscale representation to generate the past frame output mask weighted grayscale image. This overlaying process combines the spatial and contextual information from the guidance map with the grayscale representation of the past frame. The overlaying outputs the past frame output mask weighted grayscale image of the cropped image. The weighted grayscale unit (325b) constructs a 4th channel which propagates the context information of the past frame to maintain temporal stability. The weighted grayscale unit (325b) performs the below steps: it first normalizes the grayscale values, then applies a weighting function based on the guidance map, and finally combines the weighted values to produce the output mask. This process ensures that the temporal coherence is maintained, and the segmentation results are consistent across frames:

For each pixel (i, j) in (H,W)

$$If segmentation\_output ( i , j ) = 0 ,$$

$$result = 0.2 * grayscale\_image ( i , j ) + 0.8 * 20$$

$$If segmentation\_output ( i , j ) = 255 ,$$

$$result = 0.2 * grayscale\_image ( i , j ) + 0.8 * 240$$

At step S19, the weighted gray-scale unit (325b) inputs the past frame output mask weighted grayscale image to a spatio-color mesh grid unit (327b). The spatio-color mesh grid unit (327b) constructs 5th channel which propagates the color and positional information of past frame to maintain temporal stability. The spatio-color mesh grid unit (327b) constructs a fused spatio-color mesh grid using color channels (U,V) of the past frame and X, Y gradient. The channels of the past frame are obtained using YUV encoding of the past frame.

At step S20, the cropped image, the past frame output mask weighted grayscale image, the fused spatio-color mesh grid is input to a concatenation unit (329b). The concatenation unit 329b concatenates the cropped image, the past frame output mask weighted grayscale image, the fused spatio-color mesh grid to generate a pre-processed image (331b) of the input frame (311). The pre-processed image (331b) are the cropped versions of shaded background. At step S22, the pre-processed image (331b) is input to a selective segmentation unit (333b). The selective segmentation unit (333b) performs the segmentation and generates the segmentation output (335b). At step S14, the segmentation output (335b) can be used as the input for the segmentation of the next frame in the video.

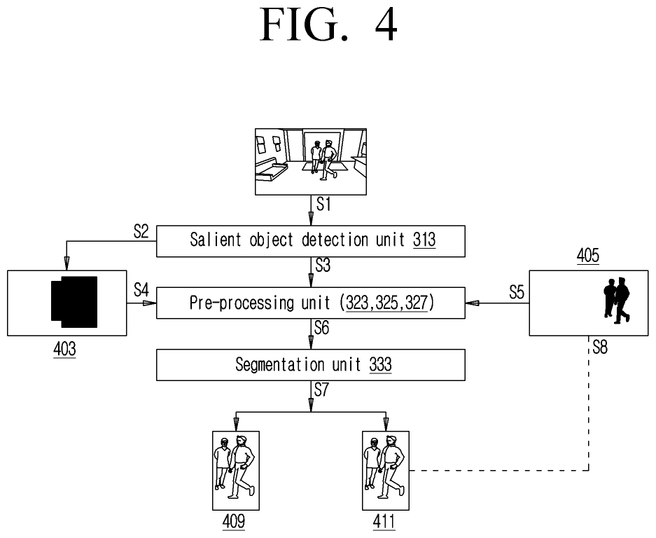

FIG. 4 is a diagram illustrating an adaption of guidance map for the input frame according to various embodiments. At step S1, an input frame (401) is provided as the input to the salient object detection unit (313). The salient object detection unit (313) detects the salient objects in the input frame. The detection process includes analyzing the frame using convolutional neural networks (CNNs) to identify regions with high contrast, unique textures, or distinct colors that stand out from the background. Upon the salient object detection, at step S2, the guidance maps for the input frame are generated based on the detected salient objects. The guidance map (403) is a spatial representation that highlights the detected salient regions, which can be used to focus subsequent processing steps. When the input media is an image, the guidance map (403) is generated based on the salient objects detected in the input frame (401). When the input media is a video and the input frame is the first frame, the guidance map (403) is generated based on the salient objects detected in the input frame (401). For subsequent frames in a video, the guidance map (405) is generated based on the previous frame output, ensuring temporal consistency. At step S3, the detected salient objects in the input frame (401) are provided as input to a pre-processing unit (hereinafter the pre-processing unit is combinedly used for cropping unit, weighted gray-scale unit, and spatio-color mesh grid unit). The pre-processing unit (323, 325, 327) performs several operations, including cropping the input frame to focus on the salient regions, converting the frame to a weighted grayscale image to emphasize important features, and generating a spatio-color mesh grid representation to capture spatial and color information. At steps S4 and S5, the guidance map (403) or the guidance map (405) is provided as input to the pre-processing unit (323, 325, 327). The pre-processing unit (323, 325, 327) crops the input frame, determines the past frame output mask, generates a weighted grayscale image, and creates a fused spatio-color mesh grid representation for the cropped image frame. The cropped image, past frame output mask, weighted grayscale image, and fused spatio-color mesh grid representation are combined to produce a pre-processed image. At step S6, the pre-processed image is provided as input to the segmentation unit (333). The segmentation unit (333) performs the segmentation of the pre-processed image and provides an output frame (409) when the input media is an image frame. The segmentation process includes partitioning the image into regions corresponding to different objects or parts of objects. For video input, the segmentation unit (333) performs the segmentation of the pre-processed image and provides an output frame (411), ensuring that the segmentation is consistent across frames.

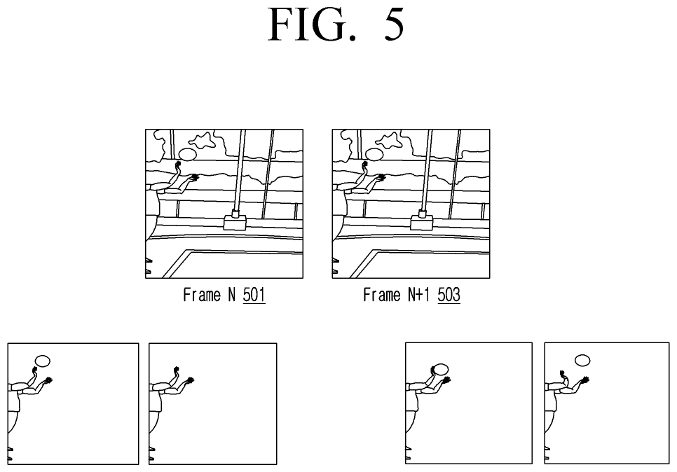

FIG. 5 is a diagram illustrating the importance of the guidance map during the segmentation of the input frame according to various embodiments. For example, consider an input frame N (501) and the input frame N+1 (503). A segmented output image (505) of frame N (501) and a segmented output image (507) of frame N+1 (503) are obtained by performing the segmentation without the guidance map. The absence of the guidance map can lead to inconsistencies and inaccuracies in the segmentation, as the algorithm may not have context to distinguish between foreground and background elements. However, the segmented output image (509) of frame N (501) and the segmented output image (511) of frame N+1 (503) are obtained by performing the segmentation with the guidance map. The guidance map provides additional information about the salient regions, allowing the segmentation algorithm to focus on the important areas and maintain temporal coherence. Thus, the segmented output images (509, 511) yield efficient results during the segmentation since the guidance map enables the information transfer between past and present frames, leading to improved temporal stability. This results in smoother transitions and more accurate object boundaries in the segmented output.

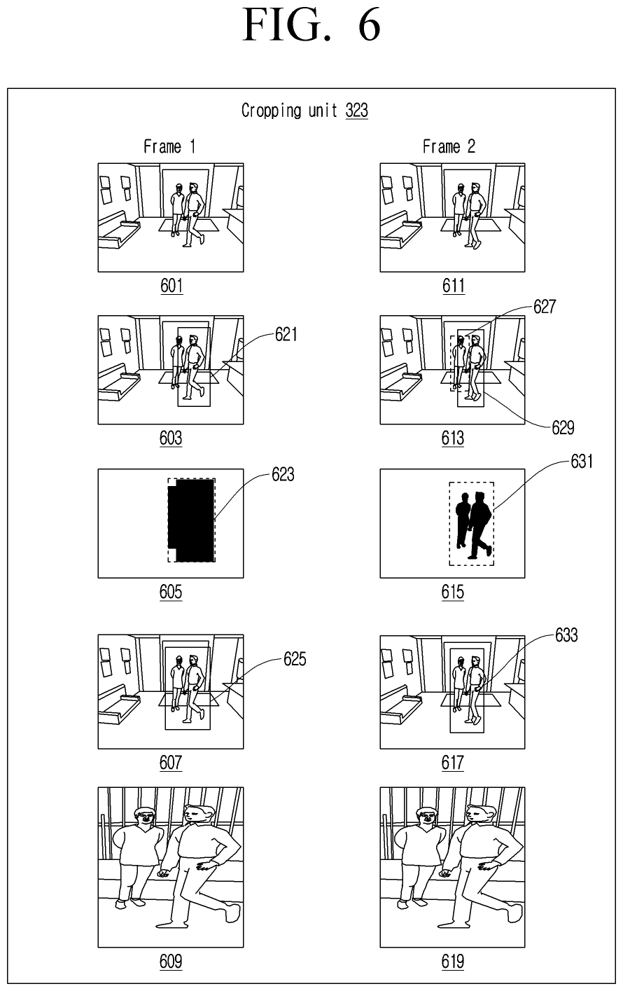

FIG. 6 is a diagram illustrating example cropping of the input frame in salient mode using the guidance map according to various embodiments. Consider the cropping unit (323) performs a cropping of the first frame of the video, which is the input frame (601). The input frame (H, W) has a height H and width W. The cropping unit (323) analyzes the frame to identify regions of interest (ROIs) that include salient objects. Further, at block 603, the cropping unit (323) determines the salient ROIs (621, 623) of the salient objects detected. The salient ROIs are the bounding boxes (Bi) generated for the salient objects, which are areas of the frame that include the visual information. At block 605, the cropping unit captures the guidance map (621) for the input frame (601). The guidance map highlights the salient regions, providing a reference for the cropping process. At block 607, the cropping unit (323) performs the intersection of the guidance map (621) and the salient ROIs (621, 623) detected. The intersecting area (627) is generated as a result of the intersection, which is further used for segmentation. The intersecting area represents the regions of the frame that are both salient and highlighted by the guidance map. The cropping unit (323) crops the input frame (601), retaining the intersecting area (627) and removing unnecessary background noise other than the intersecting area (627), resulting in the cropped image frame (609). This ensures that the cropped frame focuses on the important regions.

Similarly, consider the cropping unit (323) performs a cropping of the second frame (611) of the video. The second frame (H, W) has a height H and a width W. The cropping unit (323) continues to analyze the frame to identify salient ROIs. At block 613, the cropping unit (323) determines the salient ROIs (629, 631) of the salient objects detected. The salient ROIs are the bounding boxes (Bi) generated for the salient objects. At block 615, the cropping unit receives the guidance map (633) for the past frame (601). The guidance map provides context from the previous frame, ensuring temporal consistency. At block 617, the cropping unit (323) performs the intersection of the guidance map (633) and the salient ROIs (629, 631) detected. The intersecting area (635) is generated as a result of the intersection, which is further used for segmentation. The cropping unit (323) crops the second frame (611), retaining the intersecting area (635) and removing unnecessary background noise other than the intersecting area (635), resulting in the cropped image frame (619). This process ensures that the cropped frame maintains focus on the important regions.

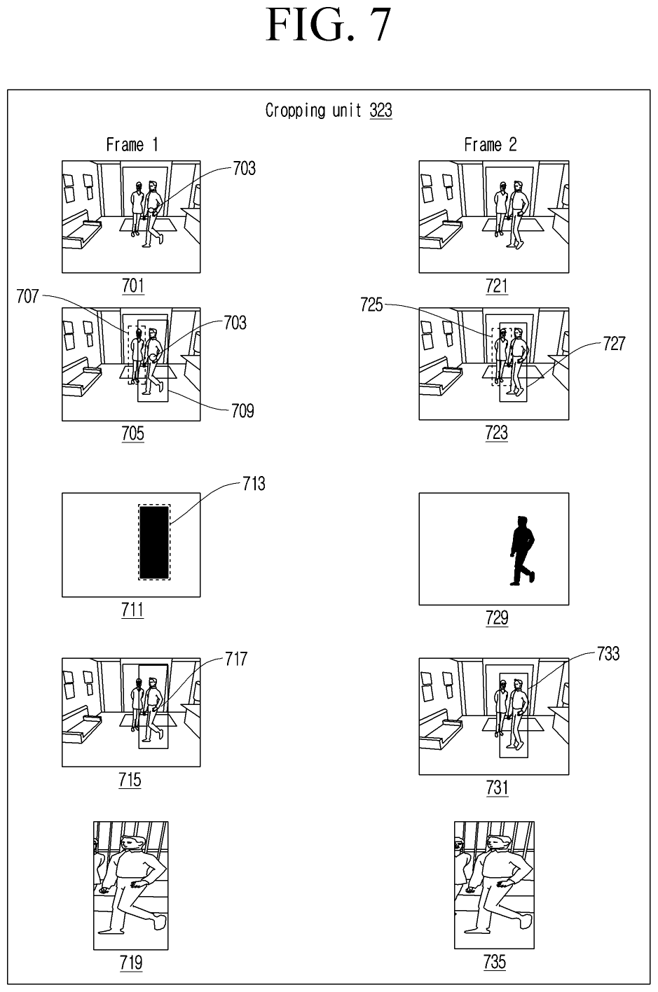

FIG. 7 is a schematic diagram illustrating example cropping of the input frame in selective mode using the guidance map according to various embodiments. Consider the cropping unit (323) performs a cropping of the first frame of the video, which is the input frame (701). The input frame (H, W) has a height H and width W. The user can select an object for which the segmentation needs to be performed. For example, the user (703) in the input frame (701) is selected by the user for segmentation. The user selection allows for more targeted processing, focusing on specific objects of interest. At block 705, the cropping unit (323) determines the salient ROIs (707, 709) of the salient objects detected. The salient ROIs are the bounding boxes (Bi) generated for the salient objects. At block 711, the cropping unit (323) receives the guidance map (713) for the selected object in the input frame (701). Since the input frame (701) is the first frame, the guidance map (713) is determined based on the salient ROIs of the selected object. The guidance map provides additional context for the selected object, ensuring accurate cropping. At block 715, the cropping unit (323) performs the intersection of the guidance map (713) and the salient ROIs (709) of the selected object (703). The intersecting area (717) is generated as a result of the intersection, which is further used for segmentation. The cropping unit (323) crops only the selected object (703) in the input frame (701), retaining the intersecting area (717) and removing unnecessary background noise other than the intersecting area (717), resulting in the cropped image frame (719). This ensures that the cropped frame focuses on the user-selected object.

Consider the cropping unit (323) performs a cropping of the second frame (721) of the video. The second frame (H, W) has a height H and a width W. The selected user (703) is continued for the second frame (721). The cropping unit (323) continues to analyze the frame to identify salient ROIs. At block 723, the cropping unit (323) determines the salient ROIs (727, 725) of the salient objects detected. The salient ROIs are the bounding boxes (Bi) generated for the salient objects. At block 729, the cropping unit (323) receives the guidance map (713) for the selected object in the input frame (701). Since the input frame (701) is the first frame, the guidance map (713) is determined based on the past frame segmentation output. The guidance map provides context from the previous frame, ensuring temporal consistency. At block 731, the cropping unit (323) performs the intersection of the guidance map (729) and the salient ROIs (727) of the selected object (703). The intersecting area (733) is generated as a result of the intersection, which is further used for segmentation. The cropping unit (323) crops only the selected object (703) in the input frame (721), retaining the intersecting area (733) and removing unnecessary background noise other than the intersecting area (733), resulting in the cropped image frame (735).

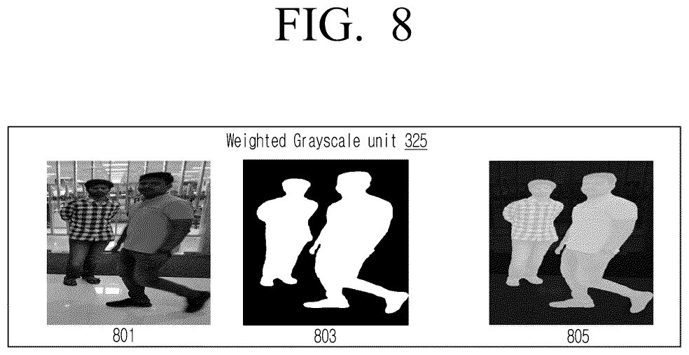

FIG. 8 is a schematic diagram illustrating example determination of the weighted grayscale representation of the input frame, according to various embodiments. The weighted grayscale unit (325) constructs 4th channel, which propagates the context information of past frame to maintain temporal stability. In the selective mode, this channel information helps in maintaining consistency of the selected object segmentation throughout the video. Also, the past frame segmentation output is overlaid on the past frame grayscale representation with a proportion to construct a weighted representation, which will be used as 4th channel. For example, consider the block 801 represents the grayscale representation of the past frame segmentation output and the block 803 represents the past frame segmentation output. The weighted grayscale unit (325) overlays the block 801 over the block 803 that results in the past frame output mask weighted grayscale image shown in block 805.

The past frame output mask weighted grayscale image is determined as below:

For each pixel (i, j) in (H,W)

$$If segmentation\_output ( i , j ) = 0 ,$$

$$result = 0.2 * grayscale\_image ( i , j ) + 0.8 * 20$$

$$If segmentation\_output ( i , j ) = 255 ,$$

$$result = 0.2 * grayscale\_image ( i , j ) + 0.8 * 240.$$

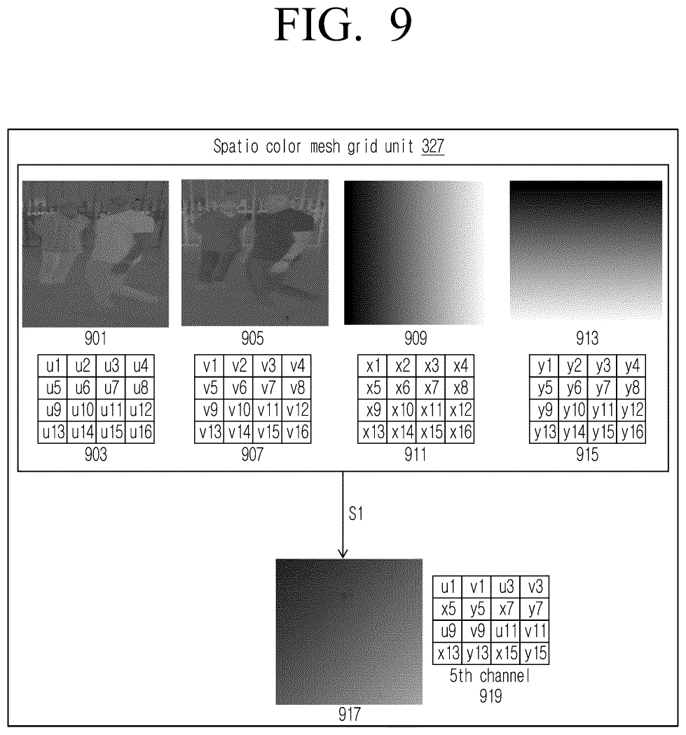

FIG. 9 is a diagram illustrating example spatio-color mesh grid representation of the input frame according to various embodiments. The spatio-color mesh grid unit (327) component constructs a 5th channel which propagates the color and positional information of the past frame to maintain temporal stability. This 5th channel ensures that the transitions between frames are smooth and free from artifacts. The spatio-color mesh constructs an single-channel spatio-color mesh grid representation using U and V channels from YUV encoding of the past frame and X and Y gradients. The U and V channels provide chrominance information, while the X and Y gradients offer spatial information about the changes in intensity across the frame.

The spatio-color mesh grid unit (327) is provided an input of the cropped past frame in YUV encoding (H, W, 3), X gradient (H, W), and Y gradient (H, W). The YUV encoding separates the luminance (Y) from the chrominance (U and V). The X and Y gradients are calculated using edge detection algorithms, such as the Sobel operator, which highlight the edges and transitions within the frame. The spatio-color mesh grid unit (327) fuses the past frame U and V channels and X and Y gradients to construct the fifth channel. This fusion process includes a weighted combination of the chrominance and gradient information to create a comprehensive representation of the frame's spatial and color characteristics.

For example, consider the blocks (901, 903) represent the past frame U channel components, the blocks (905, 907) represent the past frame V channel components, the blocks (909, 911) represent the X-gradient, and the blocks (913, 915) represent Y-gradients. These blocks are sub-regions of the frame that include specific chrominance and gradient information. Further, at step S1, the spatio-color mesh grid unit (327) fuses the blocks (901, 905, 909, and 913) together, resulting in the fused spatio-color mesh grid representation (917, 919) as the 5th channel. This fused representation is then used in subsequent processing steps to enhance the temporal stability and visual quality of the video sequence. The fusion process may involve convolutional neural networks (CNNs) or other machine learning techniques to optimize the combination of these diverse data sources.

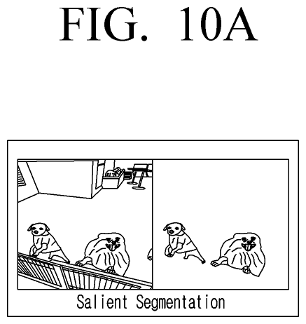

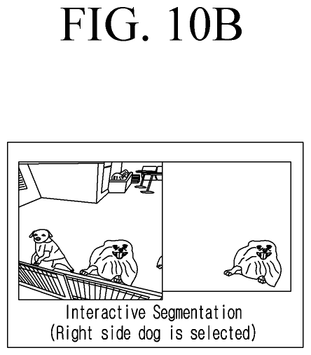

FIG. 10A is a diagram illustrating an example segmentation output image for the input image obtained by the unified segmentation controller (309) in salient mode according to various embodiments. In this mode, the system automatically identifies and segments the prominent or salient objects within the input frame. As depicted in FIG. 10A, the salient segmentation highlights the dog in the frame, which is identified as the prominent object.

FIG. 10B is a diagram illustrating an example segmentation output image for the input image obtained by the unified segmentation controller (309) in selective mode according to various embodiments. In this mode, the system allows user interaction to selectively segment specific objects within the input frame. As shown in FIG. 10B, the user has selected the dog on the right-hand portion of the frame, and the system has segmented this specific object accordingly.

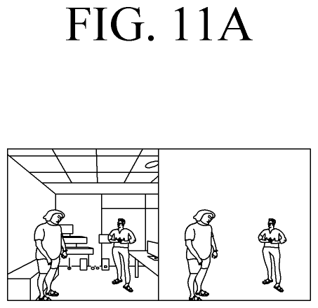

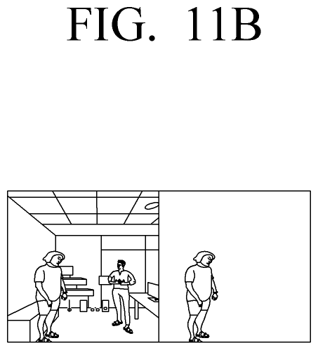

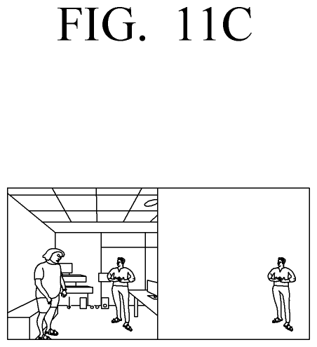

FIG. 11A is a diagram illustrating an example segmentation output image for the input image obtained by the unified segmentation controller (309) in salient mode according to various embodiments. Similar to FIG. 10A, the system automatically identifies and segments the prominent objects within the input frame. In FIG. 11A, the salient segmentation highlights the people in the frame as the prominent object the frame as the prominent object.

FIG. 11B is a diagram illustrating an example segmentation output image for the input image obtained by the unified segmentation controller (309) in selective mode according to various embodiments. Here, the user has selected the person on the left side portion of the frame, and the system has segmented this specific object accordingly.

FIG. 11C is a diagram illustrating an example segmentation output image for the input image obtained by the unified segmentation controller (309) in selective mode according to various embodiments. In this scenario, the user has selected the person on the right side portion of the frame, and the system has segmented this specific object as per the user's selection.

The unified segmentation controller (309) thus provides flexibility in processing input images by offering both automatic salient segmentation and user-interactive selective segmentation modes, enhancing the utility and adaptability of the system in various applications.

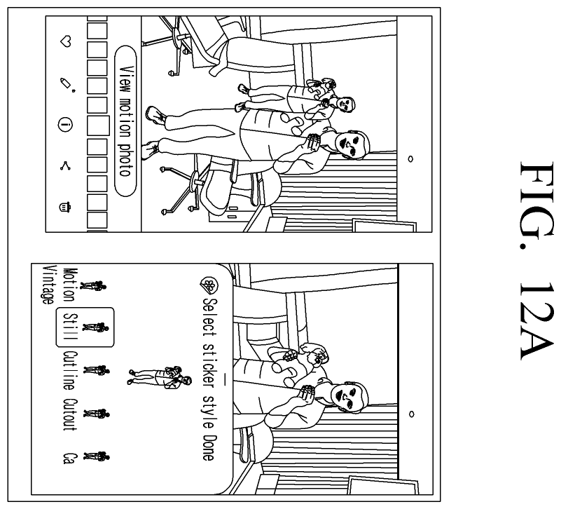

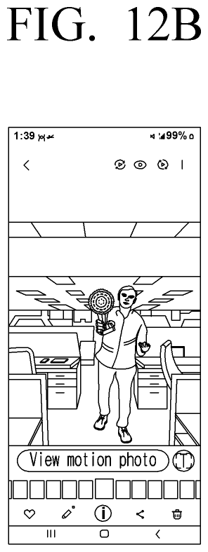

FIG. 12A is a diagram illustrating an example segmentation output image in the image clipper feature according to various embodiments. The system processes the input image to segment various elements within the scene, such as the person standing and the surrounding furniture. The unified segmentation controller (309) is responsible for identifying and isolating these elements, enabling the user to apply different sticker styles, such as motion, vintage, still, outline, and cutout. The user interface allows for selection and application of these styles, enhancing the visual representation of the segmented image.

FIG. 12B is a diagram illustrating an example segmentation output image in the motion clipper feature according to various embodiments. Similar to the image clipper feature, the unified segmentation controller (309) processes the input image to identify and segment elements within the scene. The system enables the user to view a motion photo, which incorporates dynamic elements segmented from the static background. The user interface provides options for adjusting and customizing the motion photo, ensuring that the segmented elements are accurately represented and visually appealing.

The description of various example embodiments reveals their general nature, allowing those skilled in the art to modify or adapt them for various applications without departing from the core concept. Such adaptations are intended to be within the scope of the disclosed embodiments. The terminology used is for descriptive purposes only and not limiting. While various example embodiments are described, those skilled in the art will recognize that modifications are possible within the scope of the described embodiments. It will also be understood that any of the embodiment(s) described herein may be used in conjunction with any other embodiment(s) described herein.

What is claimed is:

1. A method for unified segmentation of media by an electronic apparatus, comprising:
determining, by the electronic apparatus, a guidance map for an input frame based on at least one salient object, a past frame output mask, and a user-interacted object in the media in one of a salient mode and a selective mode;
cropping, by the electronic apparatus, the input frame of an input media based on the guidance map and salient Regions of Interest (ROIs) of the at least one salient object;
determining, by the electronic apparatus, a past frame output mask weighted grayscale image of a cropped image frame;
determining, by the electronic apparatus, a fused spatio-color mesh grid representation for the cropped image frame in a YUV format;
inputting, by the electronic apparatus, the cropped image frame along with the past frame output mask weighted grayscale image and the fused spatio-color mesh grid representation to a segmentation model; and
generating, by the electronic apparatus, one of a salient object segmentation and a user-interacted object segmentation for the media using the segmentation model in the electronic apparatus.

2. The method as claimed in claim 1, wherein detecting the at least one salient object in the input frame of an input media in the salient mode comprises:
generating, by the electronic apparatus, a bounding box for one or more objects present in the input frame;
determining, by the electronic apparatus, at least one of a height and width of the bounding box, centerness of the bounding box and category of the objects in the bounding box;
determining, by the electronic apparatus, a combined score for all the bounding boxes based on the height and width of the bounding box, centerness of the bounding box and the category of the objects in the bounding box; and
detecting the at least one salient object in the input frame of an input media based on the combined score of the bounding box, wherein the input media is at least one of an image or video.

3. The method as claimed in claim 1, wherein detecting the at least one salient object in the input frame of the input media in the selective mode comprises:
displaying a plurality of salient objects in the input frame of the input media on a screen of the electronic apparatus;
receiving an input select of at least one salient object from the plurality of salient objects; and
detecting the at least one salient object in the input frame of the input media in the selective mode based on the input.

4. The method as claimed in claim 1, wherein the input media is at least one of an image or a video.

5. The method as claimed in claim 1, wherein the guidance map is the at least one salient ROIs of the input frame, based on the input frame being the image or based on the input frame being a first frame of a video.

6. The method as claimed in claim 1, wherein the guidance map includes a segmentation output of the past frame, based on the input frame not being the image or based on the input frame not being a first frame of the video.

7. The method as claimed in claim 1, wherein cropping the input frame of the input media based on the guidance map comprises:
determining, by the electronic apparatus, at least one salient Regions of Interest (ROIs) having intersection in the input frame among the at least one salient object;
performing, by the electronic apparatus, one of:
generating, by the electronic apparatus, the cropped image frame of the input frame by combining the at least one salient ROIs and the guidance map of the input frame, based on the input media being the image and based on the input frame being a first frame of the video; or
generating, by the electronic apparatus, the cropped image of the input frame by combining the at least one salient ROIs and the guidance map of the past frame, based on the input media being the video and the input frame not being the first frame.

8. The method as claimed in claim 1, wherein cropping the input frame of an input media based on the guidance map comprises:
determining, by the electronic apparatus, at least one salient Region of Interest (ROIs) having an intersection in the input frame among the at least one salient object;
receiving, by the electronic apparatus, an input selecting of at least one selected coordinates from plurality of salient objects;
performing, by the electronic apparatus, one of:
generating, by the electronic apparatus, the cropped image of the input frame by combining the at least one salient ROIs, a guidance map with selected coordinates of the input frame, based on the input media being the image and based on the input frame being a first frame of the video; or
generating, by the electronic apparatus, the cropped image of the input frame by combining the at least one salient ROIs and the guidance map of the past frame, based on the input media being the video and the input frame not being the first frame.

9. The method as claimed in claim 1, wherein determining the past frame output mask weighted grayscale image of a cropped image frame comprises:
overlaying, by the electronic apparatus, a past frame segmentation output on a past frame grayscale representation with a proportion; and
determining, by the electronic apparatus, the past frame output mask weighted grayscale image of a cropped image based on the overlaying.

10. The method as claimed in claim 1, wherein the fused spatio-color mesh grid comprises a U-channel, a V-channel, and a X-Y component fused together.

11. An electronic apparatus for performing a unified segmentation of a media, comprises:
at least one processor comprising processing circuitry; and
an unified segmentation controller comprising circuitry communicatively coupled with at least one processor, wherein the unified segmentation controller is configured to cause the electronic apparatus to:
determine a guidance map for an input frame based on at least one salient object, a past frame output mask, and a user-interacted object in the media in one of a salient mode and a selective mode;
crop the input frame of an input media based on the guidance map and salient Regions of Interest (ROIs) of the at least one salient object;
determine a past frame output mask weighted grayscale image of a cropped image frame;
determine a fused spatio-color mesh grid representation for the cropped image frame in a YUV format;
input the cropped image frame along with the past frame output mask weighted grayscale image and the fused spatio-color mesh grid representation to a segmentation model; and
generate one of a salient object segmentation and a user-interacted object segmentation for the media using the segmentation model in the electronic apparatus.

12. An electronic apparatus as claimed in claim 11, wherein the unified segmentation controller is configured to cause the electronic apparatus to:
generate a bounding box for one or more objects present in the input frame;
determine at least one of a height and width of the bounding box, centerness of the bounding box and category of the objects in the bounding box;
determine a combined score for all the bounding boxes based on the height and width of the bounding box, centerness of the bounding box and the category of the objects in the bounding box; and
detect the at least one salient object in the input frame of an input media based on the combined score of the bounding box, wherein the input media is at least one of an image or video.

13. An electronic apparatus as claimed in claim 11, wherein the unified segmentation controller is configured to cause the electronic apparatus to:
display a plurality of salient objects in the input frame of the input media on a screen of the electronic apparatus;
receive an input selecting at least one salient object from the plurality of salient objects; and
detect the at least one salient object in the input frame of the input media in the selective mode based on the input.

14. An electronic apparatus as claimed in claim 11, wherein the input media is at least one of an image or a video.

15. An electronic apparatus as claimed in claim 11, wherein the guidance map is the at least one salient ROIs of the input frame, based on the input frame being the image or based on the input frame being a first frame of a video.

16. An electronic apparatus as claimed in claim 11, wherein the guidance map includes a segmentation output of the past frame, based on the input frame not being the image or based on the input frame not being a first frame of the video.

17. An electronic apparatus as claimed in claim 11, wherein the unified segmentation controller is configured to cause the electronic apparatus to:
determine at least one salient Regions of Interest (ROIs) having intersection in the input frame among the at least one salient object; and
perform one of:
generating, by the electronic apparatus, the cropped image frame of the input frame by combining the at least one salient ROIs and the guidance map of the input frame, based on the input media being the image and based on the input frame being a first frame of the video; or
generating, by the electronic apparatus, the cropped image of the input frame by combining the at least one salient ROIs and the guidance map of the past frame, based on the input media being the video and the input frame not being the first frame.

18. An electronic apparatus as claimed in claim 11, wherein the unified segmentation controller is configured to cause the electronic apparatus to:
determine, at least one salient Region of Interest (ROIs) having an intersection in the input frame among the at least one salient object;
receive an input selecting of at least one selected coordinates from plurality of salient objects; and
perform one of:
generating, by the electronic apparatus, the cropped image of the input frame by combining the at least one salient ROIs, a guidance map with selected coordinates of the input frame, based on the input media being the image and based on the input frame being a first frame of the video; or
generating, by the electronic apparatus, the cropped image of the input frame by combining the at least one salient ROIs and the guidance map of the past frame, based on the input media being the video and the input frame not being the first frame.

19. An electronic apparatus as claimed in claim 11, wherein the unified segmentation controller is configured to cause the electronic apparatus to:
overlay a past frame segmentation output on a past frame grayscale representation with a proportion; and
determine the past frame output mask weighted grayscale image of a cropped image based on the overlaying.

20. An electronic apparatus as claimed in claim 11, wherein the fused spatio-color mesh grid comprises a U-channel, a V-channel, and a X-Y component fused together.
